(19) United States
(12) Patent Application Publication
(10) Pub. No.: US 2025/0197179 A1
(43) Pub. Date: Jun. 19, 2025

(54) ROBOTIC VEHICLE FORKS-ENGAGED SENSOR AND METHOD OF USING SAME

(71) Applicant: Seegrid Corporation, Pittsburgh, PA (US)

(72) Inventor: Raul Espinosa, Cranberry Township, PA (US)

(21) Appl. No.: 18/975,477

(22) Filed: Dec. 10, 2024

Related U.S. Application Data
(60) Provisional application No. 63/610,505, filed on Dec. 15, 2023.

(51) Int. Cl. B66F 9/06; B66F 9/075; B66F 9/24

(52) U.S. Cl. CPC B66F 9/063; B66F 9/0755; B66F 9/24

(57) ABSTRACT

In accordance with one aspect of the inventive concepts, provided is forks-engagement system and an autonomous mobile robot (AMR) comprising same. The AMR can comprise at least one processor in communication with at least one computer memory device, forks include fork tines configured to engage a payload, at least one forks-engaged sensor positioned on or in the fork tines, and a forks monitoring system. The forks monitoring system can comprise computer program code executable by the at least one processor to process an output from the forks-engaged sensor to determine if the fork tines are engaged or disengaged from the payload. When the forks, or fork tines, are engaged with the payload, the monitoring system can signal for an adjustment of the forks. When the forks are no longer in contact with a pallet, or disengaged, the monitoring system can signal for a retraction of the forks.

### CROSS REFERENCE TO RELATED APPLICATIONS

The present application claims priority to U.S. Provisional Patent Application 63/610,505, filed Dec. 15, 2023, entitled, Robotic Vehicle Forks-Engaged Sensor and Method of Using Same, which is incorporated herein by reference.

The present application may be related to U.S. Provisional Appl. 63/729,527 filed Dec. 9, 2024, entitled System and Method for Picking Industrial Infrastructure from Dynamically Sized Stacks, U.S. Provisional Appl. 63/430,184 filed on Dec. 5, 2022, entitled Just in Time Destination Definition and Route Planning; U.S. patent application Ser. No. 18/529,109, filed on Dec. 5, 2023, US Publication Number 2024/0184293, Published on Jun. 6, 2024, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution U.S. patent application Ser. No. 18/526,538, filed on Dec. 1, 2023, US Publication Number 2024/0185178, Published on Jun. 6, 2024, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. patent application Ser. No. 18/527,669, filed on Dec. 4, 2023, US Publication Number 2024/0182283, Published on Jun. 6, 2024, entitled Systems and Methods for Material Flow Automation; U.S. Provisional Appl. 63/430,174 filed on Dec. 5, 2022, entitled Process Centric User Configurable Step Framework for Composing Material Flow Automation; U.S. patent application Ser. No. 18/527,699, filed on Dec. 4, 2023, US Publication Number 2024/0181645, Published on Jun. 6, 2024, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. patent application Ser. No. 18/527,715, filed on Dec. 4, 2023, US Publication Number 2024/0184269, Published on Jun. 6, 2024, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. patent application Ser. No. 18/524,217, filed on Nov. 30, 2023, US Publication Number 2024/0182282, Published on Jun. 6, 2024, entitled Hybrid Autonomous System and Human Integration System and Method Logic; U.S. Provisional Appl. 63/430,180 filed on Dec. 5, 2022, entitled A System for Process Flow Templating and Duplication of Tasks Within Material Flow Automation; U.S. patent application Ser. No. 18/527,730, filed on Dec. 4, 2023, US Publication Number 2024/0184540, Published on Jun. 6, 2024, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); U.S. patent application Ser. No. 18/529,229, filed on Dec. 5, 2023, US Publication Number 2024/0184312, Published on Jun. 6, 2024, entitled A Method for Abstracting Integrations Between Industrial Controls and Autonomous Mobile Robots; and U.S. Provisional Appl. 63/430,170 filed on Dec. 5, 2022, entitled Visualization of Physical Space Robot Queuing Areas as Non Work Locations for Robotic Operations; U.S. patent application Ser. No. 18/529,236, filed on Dec. 5, 2023, US Publication Number 2024/0184302, Published on Jun. 6, 2024, entitled Visualization of Physical Space Robot Queuing Areas as Non Work Locations for Robotic Operations, each of which is incorporated herein by reference in its entirety.

U.S. Provisional Appl. 63/615,833 filed on Dec. 29, 2023, entitled Object Detection and Localization from Three-Dimensional (3S) Point Clouds Using Fixed Scale (FS) Images;

U.S. Provisional Appl. 63/348,520 filed on Jun. 3, 2022, entitled System and Method for Generating Complex Runtime Path Networks from Incomplete Demonstration of Trained Activities; U.S. patent application Ser. No. 18/862,690, filed on Nov. 4, 2024, US Publication Number ______, Published on ______, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. patent application Ser. No. 18/373,544, filed on Sep. 27, 2023, US Publication Number 2024/0111585, Published on Apr. 4, 2024, entitled Shared Resource Management System and Method; U.S. Provisional Appl. 63/346,483 filed on May 27, 2022, entitled System and Method for Performing Interactions with Physical Objects Based on Fusion of Multiple Sensors; U.S. patent application Ser. No. 18/862,699, filed on Nov. 4, 2024, US Publication Number ______, Published on ______, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. patent application Ser. No. 18/849,310, filed on Sep. 20, 2024, US Publication Number ______, Published on ______, entitled Lane Grid Setup for Autonomous Mobile Robot; U.S. Provisional Appl. 63/423,679, filed Nov. 8, 2022, entitled System and Method for Definition of a Zone of Dynamic Behavior with a Continuum of Possible Actions and Structural Locations within Same; U.S. patent application Ser. No. 18/504,927, filed on Nov. 8, 2023, US Publication Number 2024/0150159, Published on May 9, 2024, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. patent application Ser. No. 18/502,221, filed on Nov. 6, 2023, US Publication Number 2024/0152148, Published on May 9, 2024, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; U.S. patent application Ser. No. 18/503,451, filed on Nov. 7, 2023, US Publication Number 2024/0151837, Published on May 9, 2024, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-Aware Localization System For Ground Vehicles; U.S. patent application Ser. No. 18/723,611, filed on Jun. 24, 2024, US Publication Number ______, Published on ______, entitled A Hybrid, Context-Aware Localization System For Ground Vehicles;

U.S. Provisional Appl. 63/324,184 filed on Mar. 28, 2022, entitled Safety Field Switching Based On End Effector Conditions; U.S. patent application Ser. No. 18/838,795, filed on Aug. 15, 2024, US Publication Number ______, Published on ______, entitled Safety Field Switching Based On End Effector Conditions In Vehicles; U.S. Provisional Appl. 63/324,185 filed on Mar. 28, 2022, entitled Dense Data Registration From a Vehicle Mounted Sensor Via Existing Actuator; U.S. patent application Ser. No. 18/842,163, filed on Aug. 28, 2024, US Publication Number ______, Published on ______, entitled Dense Data Registration From a Vehicle Mounted Sensor; U.S. Provisional Appl. 63/324,187 filed on Mar. 28, 2022, entitled Extrinsic Calibration of a Vehicle-Mounted Sensor Using Natural Vehicle Features; U.S. patent application Ser. No. 18/848,565, filed on Sep. 19, 2024, US Publication Number ______, Published on ______, entitled Extrinsic Calibration of a Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. patent application Ser. No. 18/846,359, filed on Sep. 12, 2024, US Publication Number ______, Published on ______, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. patent application Ser. No. 18/285,030, filed on Sep. 29, 2023, US Publication Number 2024/0308825, Published on Sep. 19, 2024, entitled Passively Actuated Sensor System; U.S. Provisional Appl. 63/324,192 filed on Mar. 28, 2022, entitled Automated Identification of Potential Obstructions In A Targeted Drop Zone; U.S. patent application Ser. No. 18/723,598, filed on Jun. 24, 2024, US Publication Number ______, Published on ______, entitled Automated Identification of Potential Obstructions In A Targeted Drop Zone; U.S. Provisional Appl. 63/324,193 filed on Mar. 28, 2022, entitled Localization of Horizontal Infrastructure Using Point Clouds; U.S. patent application Ser. No. 18/842,229, filed on Aug. 28, 2024, US Publication Number ______, Published on ______, entitled Localization of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. patent application Ser. No. 18/849,629, filed on Sep. 23, 2024, US Publication Number ______, Published on ______, entitled Robotic Vehicle Navigation with Dynamic Path Adjusting; U.S. Provisional Appl. 63/324,198 filed on Mar. 28, 2022, entitled Segmentation Of Detected Objects Into Obstructions And Allowed Objects; U.S. patent application Ser. No. 18/839,465, filed on Aug. 19, 2024, US Publication Number ______, Published on ______, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; U.S. patent application Ser. No. 18/849,094, filed on Sep. 20, 2024, US Publication Number ______, Published on ______, entitled Validating the Post of a Robotic Vehicle That Allows it to Interact with an Object on Fixed Infrastructure; and U.S. Provisional Appl. 63/324,201 filed on Mar. 28, 2022, entitled A System For AMRs That Leverages Priors When Localizing Industrial Infrastructure, U.S. patent application Ser. No. 18/852,369, filed on Sep. 27, 2024, US Publication Number ______, Published on ______, entitled A System For AMRs That Leverages Priors When Localizing and Manipulating Industrial Infrastructure; each of which is incorporated herein by reference in its entirety.

The present application may be related to U.S. Design Pat. application 29/832,212, filed on Mar. 22, 2022, entitled Mobile Robot;
U.S. patent application Ser. No. 17/478,338, filed on Sep. 17, 2021, US Publication Number 2022/0088980, Published on Mar. 24, 2022, entitled Mechanically-Adaptable Hitch Guide;
U.S. patent application Ser. No. 18/928,311, filed on Oct. 28, 2024, US Publication Number ______, Published on ______, entitled Vehicle Object-Engagement Scanning System and Method; U.S. patent application Ser. No. 17/490,345, filed on Sep. 30, 2021, US Publication Number 2022/0100195, Published on Mar. 31, 2022, entitled Vehicle Object-Engagement Scanning System and Method;
U.S. patent application Ser. No. 17/197,516, filed on Mar. 10, 2021, US Publication Number 2021/0284198, Published on Sep. 16, 2021, entitled Self-Driving Vehicle Path Adaptation System and Method;
U.S. patent application Ser. No. 18/973,615, filed on Dec. 9, 2024, US Publication Number ______, Published on ______, entitled Vehicle Auto-Charging System and Method;
U.S. patent application Ser. No. 18/748,777, filed on Jun. 20, 2024, US Publication Number 2024/0336154, Published on Oct. 10, 2024, entitled Vehicle Auto-Charging System and Method;
U.S. patent application Ser. No. 18/640,045, filed on Apr. 19, 2024, US Publication Number 2024/0262222, Published on Aug. 8, 2024, entitled Vehicle Auto-Charging System and Method;
U.S. patent application Ser. No. 18/392,274, filed on Dec. 21, 2023, US Publication Number 2024/0239214, Published on Jul. 18, 2024, entitled Vehicle Auto-Charging System and Method;
U.S. patent application Ser. No. 17/163,973, filed on Feb. 1, 2021, US Publication Number 2021/0237596, Published on Aug. 5, 2021, entitled Vehicle Auto-Charging System and Method;
U.S. patent application Ser. No. 18/199,052, filed on May 18, 2023, US Publication Number 2023/0376030, Published on Nov. 23, 2023, entitled Dynamic Allocation and Coordination of Auto-Navigating Vehicles and Selectors;
U.S. patent application Ser. No. 16/892,549, filed on Jun. 4, 2020, US Publication Number 2020/0387154, Published on Dec. 10, 2020, entitled Dynamic Allocation and Coordination of Auto-Navigating Vehicles and Selectors;
U.S. patent application Ser. No. 18/928,423, filed on Oct. 28, 2024, US Publication Number ______, Published on ______, entitled Laterally Operating Payload Handling Device;
U.S. patent application Ser. No. 18/427,176, filed on Jan. 30, 2024, US Publication Number 2024/0246589, Published on Jul. 25, 2024, entitled Laterally Operating Payload Handling Device
U.S. patent application Ser. No. 17/712,660, filed on Apr. 4, 2022, U.S. Pat. No. 11,884,314, Issued on Jan. 30, 2024, entitled Laterally Operating Payload Handling Device;
U.S. patent application Ser. No. 16/103,389, filed on Aug. 14, 2018, U.S. Pat. No. 11,292,498, Issued on Apr. 5, 2022, entitled Laterally Operating Payload Handling Device;
U.S. patent application Ser. No. 14/196,147, filed on Mar. 4, 2014, U.S. Pat. No. 9,965,856, Issued on May 8, 2018, entitled Ranging Cameras Using a Common Substrate;
U.S. Design Pat. application 29/471,328, filed on Oct. 30, 2013, U.S. Pat. No. D730,847, Issued on Jun. 2, 2015, entitled Vehicle Interface Module;
U.S. Design Pat. application 29/398,127, filed on Jul. 26, 2011, U.S. Pat. No. D680,142, Issued on Apr. 16, 2013, entitled Multi-Camera Head;
U.S. patent application Ser. No. 13/168,639, filed on Jun. 24, 2011, U.S. Pat. No. 8,864,164, Issued on Oct. 21, 2014, entitled Tugger Attachment;
U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking;
U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain;
U.S. patent application Ser. No. 12/371,281, filed on Feb. 13, 2009, U.S. Pat. No. 8,755,936, Issued on Jun. 17, 2014, entitled Distributed Multi-Robot System;
U.S. patent application Ser. No. 12/361,379, filed on Jan. 28, 2009, U.S. Pat. No. 8,433,442, Issued on Apr. 30, 2013, entitled Methods for Repurposing Temporal-Spatial Information Collected by Service Robots;
U.S. patent application Ser. No. 14/487,860, filed on Sep. 16, 2014, U.S. Pat. No. 9,603,499, Issued on Mar. 28, 2017, entitled Service Robot and Method Of Operating Same; U.S. patent application Ser. No. 12/361,441, filed on Jan. 28, 2009, U.S. Pat. No. 8,838,268, Issued on Sep. 16, 2014, entitled Service Robot and Method of Operating Same;
U.S. patent application Ser. No. 12/361,300 filed on Jan. 28, 2009, U.S. Pat. No. 8,892,256, Issued on Nov. 18, 2014, entitled Methods for Real-Time and Near-Real Time Interactions with Robots That Service a Facility;
U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals;
U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; each of which is incorporated herein by reference in its entirety.

### FIELD OF INTEREST

The present inventive concepts relate to the field of autonomous mobile robots (AMRs) and/or robotic vehicles. More specifically, the present inventive concepts relate to systems and methods of positioning of forks of the robotic vehicle during payload engagement/disengagement.

### BACKGROUND

A common drop location for forklift payloads in manufacturing and logistics facilities is horizontal infrastructure. This category includes lift tables, conveyors, pallet tops, tugger cart beds, industrial racks, and others. Horizontal infrastructure may vary widely in size and material, which can create challenges for its automated identification. In addition, the physical environment in which this infrastructure is typically located may be cluttered or not well-maintained.

In autonomous forklifts constructed with autonomous mobile robot (AMR) technology, when an AMR needs to drop a payload on a horizontal infrastructure, e.g., a rack or table, the AMR needs to know the vertical position of the drop surface. It is important to verify that the payload is being engaged/disengaged properly (i.e., the payload is not being pushed during attempted engagement or dragged during attempted disengagement). This helps prevent the AMR from dropping payloads, pushing payloads, or maneuvering while payloads are not fully loaded.

Some AMRs use an infrastructure detection sensor mounted on the fork assembly to image the drop surface, estimate the pose during run time, and estimate a vertical position of the drop surface. In some cases, additionally or alternatively, the AMR may use a pre-determined or pre-measured height of the drop surface to determine the height of the drop surface.

Both these approaches have challenges. When using an infrastructure detection sensor, the system may calculate an erroneous position of the drop surface due to the infrastructure sensor being slightly deflected from its ideal position. This deflection could be caused by play in the mast or fork assembly, which can be exacerbated when carrying very heavy loads. When carrying large heavy payloads at tall heights, the ability for the infrastructure sensor to estimate the vertical position of the table is impaired given that the infrastructure sensor may be pitched forward due to play in the lift mechanism and the weight of the payload. This deflection may not be measured by the onboard AMR control system and, therefore, cannot be considered when estimating the pose of the drop surface with the infrastructure sensor. If the vertical position of the surface is not accurately estimated, then the AMR may not successfully transition the payload to the surface.

Using a pre-measured height of the drop surface has its own problems as this requires a person to accurately measure the drop height to an accuracy of less than 1 cm and such measurements can be very prone to human error.

Without an accurate understanding or determination of the drop surface, the AMR may not appropriately position the forks such that the forks can be engaged/disengaged without pushing or dragging the pallet.

### SUMMARY OF THE INVENTION

In accordance with aspects of the inventive concepts, an AMR that carries and drops loads is configured to determine or estimate a vertical position of a drop surface so that the AMR can lower the forks to the adequate height such that the pallet is resting on the drop surface and not on the top forks, but also not too low where the forks themselves are resting on the pallet. From this point, in a drop operation, the forks can be easily retracted without dragging the pallet.

In accordance with one aspect of the inventive concepts, provided is an autonomous mobile robot, comprising: at least one processor in communication with at least one computer memory device; fork tines configured to engage a forks-engageable payload; and a forks monitoring system comprising at least one forks-engaged sensor configured to acquire data indicating at least partial engagement of the fork tines with the forks-engageable payload, and configured to determine if the fork tines are at least partially engaged with the forks-engageable payload based on outputs from the at least one forks-engaged sensor.

In various embodiments, the at least one forks-engaged sensor comprises at least one sensor coupled to or within one or more of the fork tines.

In various embodiments, the at least one forks-engaged sensor comprises at least one sensor coupled to or within each fork tine.

In various embodiments, the at least one forks-engaged sensor comprises at least one sensor coupled to or within only one of the fork tines.

In various embodiments, the at least one forks-engaged sensor comprises a plurality of sensors coupled to or within at least one fork tine.

In various embodiments, the at least one forks-engaged sensor comprises at least one fork tine having a plurality of sensors.

In various embodiments, the at least one fork tine having a plurality of sensors includes a fork tine having a plurality of sensors located at different locations along a length of the fork tine.

In various embodiments, the at least one forks-engaged sensor comprises a sensor at a proximal end of a fork tine.

In various embodiments, the at least one forks-engaged sensor comprises a sensor at an intermediate location of a fork tine.

In various embodiments, the at least one forks-engaged sensor comprises a sensor at a distal end of a fork tine.

In various embodiments, the at least one forks-engaged sensor comprises at least one retractable feeler switch.

In various embodiments, the at least one forks-engaged sensor comprises at least one strain gauge sensor.

In various embodiments, the mobile robot further comprises a payload engagement module configured to adjust a position of the fork tines in response to a signal from the forks monitoring system indicating the fork tines are at least partially engaged with the forks-engageable payload.

In various embodiments, the payload engagement module is configured to vertically adjust a height of the fork tines.

In various embodiments, the payload engagement module is configured to raise the fork tines in response to the forks monitoring system outputting a signal indicating the fork tines are engaged with a bottom deck of the forks-engageable payload.

In various embodiments, the payload engagement module is configured to lower the fork tines in response to the forks monitoring system outputting a signal indicating the fork tines are engaged with a top deck of the forks-engageable payload.

In various embodiments, the payload engagement module is further configured to retract the fork tines in response to the forks monitoring system outputting a signal indicating the fork tines are disengaged from the forks-engageable payload.

In various embodiments, the forks monitoring system is configured to: indicate a first state when the at least one forks-engaged sensor determines that the fork tines are engaged with a top deck of the forks-engageable payload; indicate a second state when the at least one forks-engaged sensor determines that the fork tines are engaged with a bottom deck of the forks-engageable payload; and/or indicate a third state when the at least one forks-engaged sensor determines that the forks are positioned in a void between the top deck and the bottom deck of the forks-engageable payload.

In various embodiments, in the first state the payload engagement module is configured to vertically adjust a position of the fork tines downward relative to the top deck.

In various embodiments, in the second state the payload engagement module is configured to vertically adjust a position of the fork tines upward relative to the bottom deck.

In various embodiments, in the third state the payload engagement module is configured to retract the fork tines from the forks-engageable payload.

In various embodiments, the mobile robot further comprises at least one sensor configured to collect sensor data of a horizontal infrastructure indicating a pose of a horizontal drop surface.

In various embodiments, the payload engagement module is further configured to use the sensor data to position the forks-engageable payload on the horizontal surface.

In accordance with another aspects of the inventive concepts, provided is an autonomous mobile robot payload engagement detection method, the mobile robot comprising at least one processor in communication with at least one computer memory device and fork tines configured to engage a forks-engageable payload. The method comprises: acquiring data indicating a position of the fork tines relative to a forks-engageable payload by at least one forks-engaged sensor; and determining if the fork tines are at least partially engaged with the forks-engageable payload by a forks monitoring system processing outputs from the at least one forks-engaged sensor.

In various embodiments, the at least one forks-engaged sensor comprises at least one sensor coupled to or within one or more of the fork tines.

In various embodiments, the at least one forks-engaged sensor comprises at least one sensor coupled to or within each fork tine.

In various embodiments, the at least one forks-engaged sensor comprises at least one sensor coupled to or within only one of the fork tines.

In various embodiments, the at least one forks-engaged sensor comprises a plurality of sensors coupled to or within at least one fork tine.

In various embodiments, the at least one forks-engaged sensor comprises at least one fork tine having a plurality of sensors.

In various embodiments, the at least one fork tine having a plurality of sensors includes a fork tine having a plurality of sensors located at different locations along a length of the fork tine.

In various embodiments, the at least one forks-engaged sensor comprises a sensor at a proximal end of a fork tine.

In various embodiments, the at least one forks-engaged sensor comprises a sensor at an intermediate location of a fork tine.

In various embodiments, the at least one forks-engaged sensor comprises a sensor at a distal end of a fork tine.

In various embodiments, the forks-engaged sensor is a retractable feeler switch.

In various embodiments, the at least one forks-engaged sensor comprises at least one strain gauge sensor.

In various embodiments, the method further comprises adjusting a position of the fork tines in response to a signal from the forks monitoring system indicating the fork tines are at least partially engaged with the forks-engageable payload.

In various embodiments, the payload engagement module is configured to vertically adjust a height of the fork tines.

In various embodiments, the method further comprises raising the fork tines in response to the forks monitoring system outputting a signal indicating the fork tines are engaged with a bottom deck of the forks-engageable payload.

In various embodiments, the method further comprises lowering the fork tines in response to the forks monitoring system outputting a signal indicating the fork tines are engaged with a top deck of the forks-engageable payload.

In various embodiments, the method further comprises retracting the fork tines in response to the forks monitoring system outputting a signal indicating the fork tines are disengaged from the forks-engageable payload.

In various embodiments, the method further comprises the forks monitoring system: indicating a first state when the at least one forks-engaged sensor determines that the fork tines are engaged with a top deck of the forks-engageable payload; indicating a second state when the at least one forks-engaged sensor determines that the fork tines are engaged with a bottom deck of the forks-engageable payload; and/or indicating a third state when the at least one forks-engaged sensor determines that the forks are positioned in a void between the top deck and the bottom deck of the forks-engageable payload.

In various embodiments, the method further comprises in the first state vertically adjusting a position of the fork tines downward relative to the top deck.

In various embodiments, the method further comprises in the second state vertically adjusting a position of the fork tines upward relative to the bottom deck.

In various embodiments, the method further comprises in the third state retracting the fork tines from the forks-engageable payload.

In various embodiments, the method further comprises determining a horizontal infrastructure indicating a pose of a horizontal drop surface using sensor data from at least one sensor.

In various embodiments, the method further comprises positioning the forks-engageable payload on the horizontal surface based on the sensor data.

In accordance with another aspect of the inventive concepts, provided is a forks engagement detection system, comprising: at least one forks-engaged sensor configured for attachment to or within one or more fork tines of an apparatus configured to lift a forks-engageable payload; and a monitoring system comprising computer program code executable by at least one processor to determine if the fork tines are at least partially engaged with the forks-engageable payload based on outputs from the at least one forks-engaged sensor.

In various embodiments, the apparatus configured to lift a forks-engageable payload is robotic vehicle.

In various embodiments, the forks-engaged sensor is a retractable feeler switch.

In various embodiments, the at least one forks-engaged sensor comprises at least one strain gauge sensor.

In various embodiments, the monitoring system is configured to generate a signal for use by the robotic vehicle to adjust the position of the fork tines.

In various embodiments, the monitoring system is configured to communicate the signal to a payload engagement module configured to control the fork tines.

In various embodiments, the monitoring system is configured to output a signal to adjust a position of the fork tines relative to the forks-engageable payload when the forks-engaged sensor is engaged with the forks-engageable payload.

In various embodiments, the monitoring system is configured to output a signal to retract the fork tines from the forks-engageable payload when the forks-engaged sensor is disengaged from the forks-engageable payload.

In various embodiments, the monitoring system is configured to: output a signal indicating a first state when the at least one forks-engaged sensor determines that the fork tines are engaged with a top deck of the forks-engageable payload; output a signal indicating a second state when the at least one forks-engaged sensor determines that the fork tines are engaged with a bottom deck of the forks-engageable payload; and/or output a signal indicating a third state when the at least one forks-engaged sensor determines that the forks are positioned in a void between the top deck and the bottom deck of the forks-engageable payload.

In various embodiments, the output signal in the first state indicates a vertical adjustment downward of the fork tines relative to the top deck of the forks-engageable payload.

In various embodiments, the output signal in the second state indicates a vertical adjustment upward of the fork tines relative to the bottom deck of the forks-engageable payload.

In various embodiments, the output signal in the third state indicates a retraction of the fork tines from the forks-engageable payload.

In accordance with another aspect of the inventive concepts, provided is a forks engagement detection method, comprising: coupling at least one forks-engaged sensor configured to or within one or more fork tines of an apparatus configured to lift a forks-engageable payload; and electronically determining if the fork tines are at least partially engaged with the forks-engageable payload based on outputs from the at least one forks-engaged sensor.

In various embodiments, the apparatus configured to lift a forks-engageable payload is robotic vehicle.

In various embodiments, the forks-engaged sensor is a retractable feeler switch.

In various embodiments, the at least one forks-engaged sensor comprises at least one strain gauge sensor.

In various embodiments, the method further comprises electronically generating a signal for use by the robotic vehicle to adjust the position of the fork tines.

In various embodiments, the method further comprises electronically communicating the signal to a payload engagement module configured to control the fork tines.

In various embodiments, the method further comprises electronically outputting a signal to adjust a position of the fork tines relative to the forks-engageable payload when the forks-engaged sensor is engaged with the forks-engageable payload.

In various embodiments, the method further comprises electronically outputting a signal to retract the fork tines from the forks-engageable payload when the forks-engaged sensor is disengaged from the forks-engageable payload.

In various embodiments, the method further comprises electronically: outputting a signal indicating a first state when the at least one forks-engaged sensor determines that the fork tines are engaged with a top deck of the forks-engageable payload; outputting a signal indicating a second state when the at least one forks-engaged sensor determines that the fork tines are engaged with a bottom deck of the forks-engageable payload; and/or outputting a signal indicating a third state when the at least one forks-engaged sensor determines that the forks are positioned in a void between the top deck and the bottom deck of the forks-engageable payload.

In various embodiments, the output signal in the first state indicates a vertical adjustment downward of the fork tines relative to the top deck of the forks-engageable payload.

In various embodiments, the output signal in the second state indicates a vertical adjustment upward of the fork tines relative to the bottom deck of the forks-engageable payload.

In various embodiments, the output signal in the third state indicates a retraction of the fork tines from the forks-engageable payload.

In accordance with another aspect of the inventive concepts, provided is a robotic vehicle with forks engagement sensing and adjustment as shown and described.

In accordance with another aspect of the inventive concepts, provided is a method robotic vehicle forks engagement sensing and adjusting as shown and described.

In accordance with another aspect of the inventive concepts, provided is a forks engagement detection system as shown and described.

In accordance with another aspect of the inventive concepts, provided is a forks engagement detection method as shown and described.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1A provides a perspective view of a robotic vehicle 100, in accordance with aspects of inventive concepts.

FIG. 1B provides a side view of a robotic vehicle with its load engagement portion retracted, in accordance with aspects of inventive concepts.

FIG. 1C provides a side view of a robotic vehicle with its load engagement portion extended, in accordance with aspects of inventive concepts.

FIG. 2 is a block diagram of an embodiment of an AMR, in accordance with aspects of the inventive concepts.

FIGS. 3A and 3B provide a side view of an AMR lowering a payload onto a drop surface, in accordance with aspects of the inventive concepts.

FIG. 4A provides a side view of an AMR having a forks engaged detection switch.

FIG. 4B provides a perspective view of forks of the AMR of FIG. 4A having the forks engaged detection switch.

FIG. 5 is a flow diagram of an embodiment of a method for vertically positioning forks of an AMR using a forks engaged detection switch, in accordance with aspects of the inventive concepts.

FIGS. 6A through 6E show different embodiments of a fork tine having at least one fork detection sensor, in accordance with aspects of the inventive concepts.

FIGS. 7A through 7E show other embodiments of a fork tine having at least one fork detection sensor, in accordance with aspects of the inventive concepts.

FIG. 8A shows a strain gauge sensor, in accordance with aspects of the inventive concepts.

FIG. 8B shows a circuit diagram of strain gauge sensors embedded in a fork tine, in accordance with aspects of the inventive concepts.

FIG. 8C shows strain gauge sensors embedded in a fork tine measuring a force applied to the fork tine.

### DESCRIPTION OF PREFERRED EMBODIMENT

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

According to the present inventive concepts, a system and method are provided in which forks, or fork tines, of a mobile robot, e.g., an AMR, are automatically positioned such that a fork-engageable payload is not pushed or dragged during engagement/disengagement of the payload. The fork-engageable payload can be or include any object configured for lifting and carrying by a pair of forks. Such objects often include fork pockets configured to receive the tines of a pair of forks. As an example, a fork-engageable object can take the form of pallet or a palletized load, i.e., a pallet carrying goods. For simplicity, a fork-engageable object will be referred to as a pallet herein, unless otherwise indicated.

The system uses at least one forks-engaged sensor, such as at least one switch, coupled to or provided within at least one fork tine of the AMR, wherein the at least one forks-engaged sensor is configured to detect whether the pallet is resting on the forks, whether the forks are resting on the pallet, or neither. In some embodiments, at least one sensor can be located on both forks as redundancy or to ensure that the pallet is not rolled left or right. In some embodiments, the at least one sensor can include a plurality of sensors on at least one fork, e.g., including 2 or 3 sensors on one fork. In some embodiments, the at least one sensor can include a plurality of sensors on each fork, e.g., including 2 or 3 sensors on each fork.

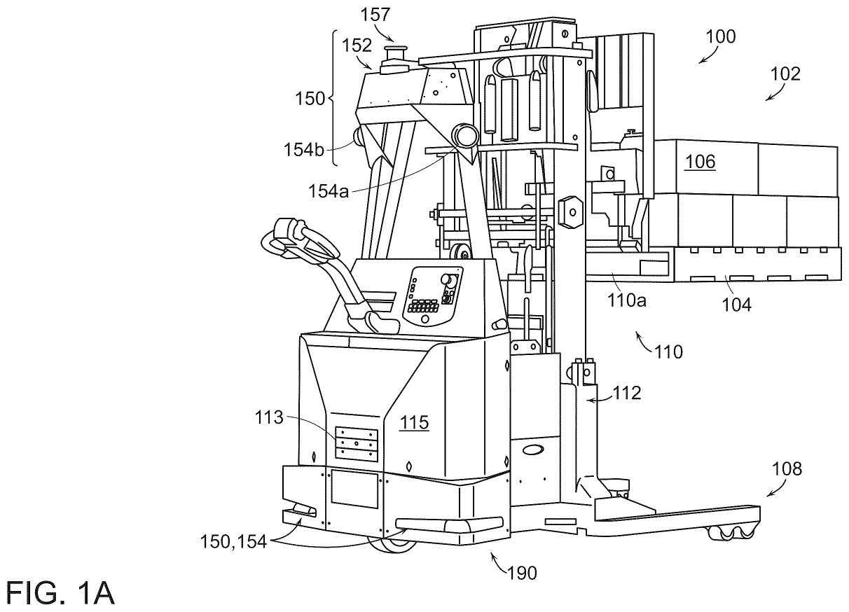

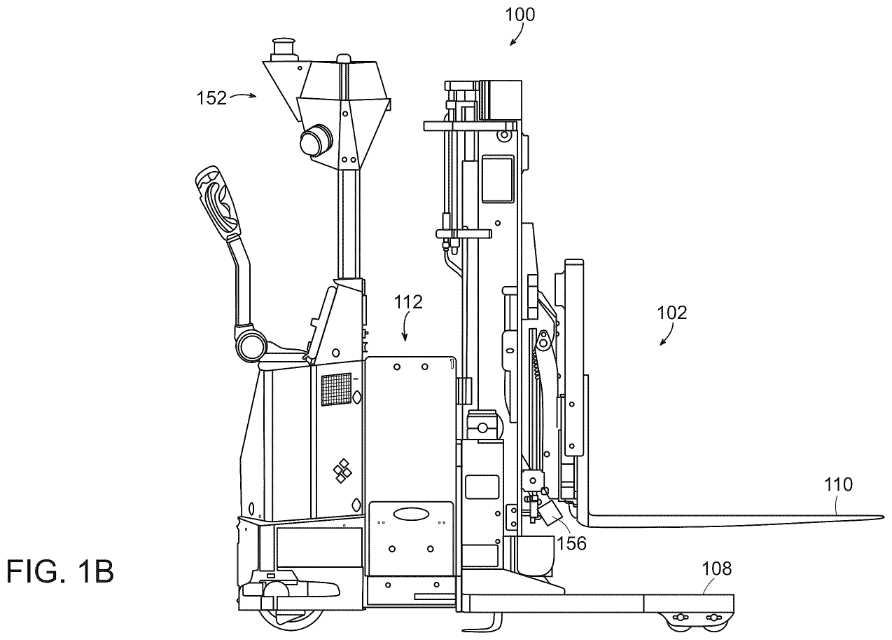

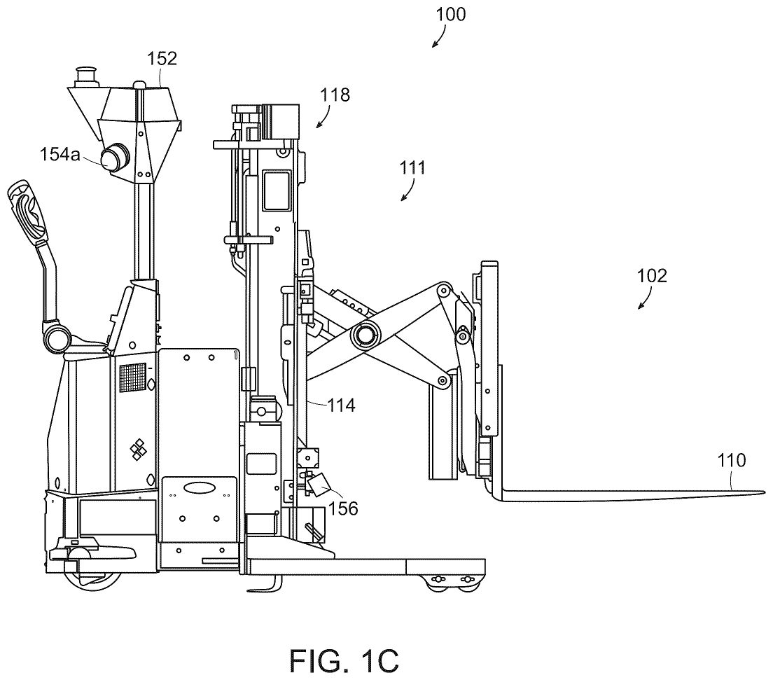

Referring to FIGS. 1A through 1C, collectively referred to as FIG. 1, shown is an example of a robotic vehicle 100 configured with the sensing, processing, and memory devices and subsystems necessary and/or useful for autonomous navigation, load engagement, and load transport. The robotic vehicle 100 takes the form of an AMR pallet lift, but the inventive concepts could be embodied in any of a variety of other types of robotic vehicles and AMRs, including, but not limited to, pallet trucks, tuggers, and the like. The AMR embodiment will be described as context for the inventive concepts.

In this embodiment, the robotic vehicle 100 includes a payload area 102 configured to transport a pallet 104 loaded with goods, which collectively form a palletized payload 106. To engage and carry the pallet 104, the robotic vehicle may include a pair of forks 110, including first and second forks 110a,b. Outriggers 108 extend from a chassis 190 of the robotic vehicle in the direction of the forks to stabilize the vehicle, particularly when carrying the palletized load. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a carriage 114 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to drop a palletized load in view of the pose of the horizontal surface that is to receive the load, or drop surface.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

The sensors 150 can include one or more stereo cameras 152 and/or other volumetric sensors, sonar sensors, radars, and/or laser imaging, detection, and ranging (LiDAR) scanners or sensors 154 and 154a,b, as examples. Inventive concepts are not limited to particular types of sensors. In various embodiments, sensor data from one or more of the sensors 150, e.g., one or more stereo cameras 152 and/or LiDAR scanners 154a,b, can be used to generate and/or update a 2-dimensional or 3-dimensional model or map of the environment, and sensor data from one or more of the sensors 150 can be used for the determining location of the robotic vehicle 100 within the environment relative to the electronic map of the environment. In the embodiment shown in FIG. 1, at least one of the LiDAR devices 154a,b can be a 2D or 3D LiDAR device. In alternative embodiments, a different number of 2D or 3D LiDAR devices are positioned near the top of the robotic vehicle 100. Also in this embodiment a LiDAR 157 is located at the top of the mast. Some embodiments LiDAR 157 is a 2D LiDAR used for localization.

In some embodiments, the sensors 150 can include sensors configured to detect objects in the payload area and/or behind the forks 110a,b. The sensors can be used in combination with others of the sensors, e.g., stereo camera head 152. In some embodiments, the sensors 150 can include one or more carriage sensors 156 oriented to collected 3D sensor data of the payload area 102 and/or forks 110. Carriage sensors 156 can include a 3D camera and/or a LiDAR scanner, as examples. In some embodiments, the carriage sensors 156 can be coupled to the robotic vehicle 100 so that they move in response to movement of the actuators 111 and/or forks 110. For example, in some embodiments, the carriage sensor 156 can be slidingly coupled to the carriage 114 so that the carriage sensors move in response to up and down movement of the forks. In some embodiments, the carriage sensors collect 3D sensor data as they move with the forks.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

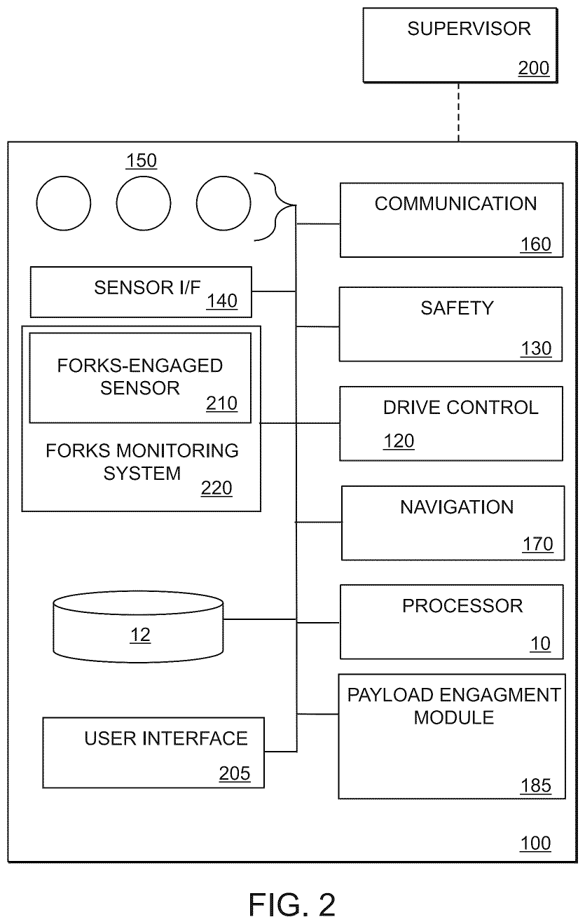

FIG. 2 is a block diagram of components of an embodiment of the robotic vehicle 100 of FIG. 1, incorporating path adaptation technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, supervisor 200 could be configured to perform, for example, fleet management and monitoring for a plurality of vehicles (e.g., AMRs) and, optionally, other assets within the environment. Supervisor 200 can be local or remote to the environment, or some combination thereof.

In various embodiments, supervisor 200 can be configured to provide instructions and data to robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with supervisor 200 and any other external systems over any now known or hereafter developed communication technology, such as various types of wireless technology including, but not limited to, WiFi, Bluetooth, cellular, global positioning system (GPS), radio frequency (RF), and so on.

As an example, supervisor 200 could wirelessly communicate a path for robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. Supervisor 200 can also monitor robotic vehicle 100, such as to determine robotic vehicle's location within an environment, battery status and/or fuel level, and/or other operating, vehicle, performance, and/or load parameters.

As is shown in FIG. 2, in example embodiments, robotic vehicle 100 includes various functional elements, e.g., components and/or modules, which can be housed within housing 115. Such functional elements can include at least one processor 10 coupled to at least one memory 12 to cooperatively operate the vehicle and execute its functions or tasks. Memory 12 can include computer program instructions, e.g., in the form of a computer program product, executable by processor 10. Memory 12 can also store various types of data and information. Such data and information can include route data, path data, path segment data, pick data, location data, environmental data, and/or sensor data, as examples, as well as the electronic map of the environment.

In this embodiment, processor 10 and memory 12 are shown onboard robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across supervisor 200, other vehicles, and/or other systems external to robotic vehicle 100.

The functional elements of robotic vehicle 100 can further include a navigation module 170 configured to access environmental data, such as the electronic map, and path information stored in memory 12, as examples. Navigation module 170 can communicate instructions to a drive control subsystem 120 to cause robotic vehicle 100 to navigate its path within the environment. During vehicle travel, navigation module 170 may receive information from one or more sensors 150, via a sensor interface (I/F) 140, to control and adjust the navigation of the robotic vehicle. For example, sensors 150 may provide sensor data to navigation module 170 and/or drive control subsystem 120 in response to sensed objects and/or conditions in the environment to control and/or alter the robotic vehicle's navigation. As examples, sensors 150 can be configured to collect sensor data related to objects, obstructions, equipment, goods to be picked, hazards, completion of a task, and/or presence of humans and/or other robotic vehicles.

The robotic vehicle may also include a human user interface module 205 configured to receive human operator inputs, e.g., a pick or drop complete input at a stop on the path. Other human inputs could also be accommodated, such as inputting map, path, and/or configuration information.

A safety module 130 can also make use of sensor data from one or more of sensors 150, including LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause drive control subsystem 120 to stop the vehicle to avoid the hazard.

In various embodiments, robotic vehicle 100 can include a payload engagement module 185. Payload engagement module 185 can process sensor data from one or more of sensors 150, such as carriage sensors 156, and generate signals to control one or more actuators that control the engagement portion of robotic vehicle 100. For example, payload engagement module 185 can be configured to robotically control actuators 111 and carriage 114 to pick and drop payloads. In some embodiments, the payload engagement module 185 can be configured to control and/or adjust the pitch, yaw, and roll of the load engagement portion of forks 110 of robotic vehicle 100.

In some embodiments, carriage sensor 156 can be mounted to a payload engagement structure of lift mast 118 to which carriage 114, or other AMR component, is movably attached that allows the sensor 156 to move vertically with the forks 110, i.e., pair of forks (or tines), that engage and disengage from a palletized load, or payload. In some embodiments, carriage sensor 156 can be another example of a sensor 150, e.g., carriage sensor 156 of FIGS. 1A-2. In some embodiments, carriage sensor 156 is a 2D LiDAR sensor that provides PLd field occlusion detection. In preferred embodiments, carriage sensor 156 is mounted to vehicle 100 so that it is positioned to determine the presence or absence of a payload relative to the forks 110. The payload engagement structure can include mast 118 to which carriage 114 and forks 110 are movably attached, so that carriage 114 and forks 110 can move up and down vertically to engage (pick), carry, and disengage from (drop off) payload 106. In various embodiments, sensor 156 is not mounted between forks 110, but at other locations on vehicle 100 to sense a presence of objects between forks 110. In preferred embodiments, carriage sensor 156 is mounted such that during use there is a direct visible path between carriage sensor 156 and forks 110 in the absence of a pallet 104 or payload 106.

In various embodiments, carriage sensor 156 could include a single laser scanner alone or in combination with other sensors. In various embodiments, carriage sensor 156 could include a plurality of laser scanners, whether 2D or 3D. In various embodiments, the payload scanner can include one or more sensors and/or scanners configured to sense the presence or absence of an object and/or an edge of an object.

In various embodiments, robotic vehicle 100 can include at least one forks-engaged sensor 210 positioned on at least one of the forks of vehicle 100 and a forks monitoring system 220 included in the vehicle's control system. An output of forks-engaged sensor 210 is monitored and read by the forks monitoring system 220 in the vehicle's control system. When lowering the payload onto a surface, the forks monitoring system can use this feedback to lower the payload until the point at which the forks are no longer engaged (i.e., payload not resting on forks, forks not resting on drop surface). At this point, the vehicle knows that forks can be extracted without dragging the payload. Therefore, forks monitoring system 220 is configured to generate a signal for use by the vehicle, e.g., payload engagement module 185, to adjust the position of the forks relative to a payload.

In various embodiments, forks-engaged sensor 210 can detect at least three states. The forks-engaged sensor 210 can detect a first state in which the pallet is engaged with the forks, e.g., resting on or in contact with the forks. In some embodiments, this state can be achieved when the pallet contacts an upper surface of forks-engaged sensor 210, e.g., triggers a switch. Forks-engaged sensor 210 can detect a second state in which the forks are engaged with the pallet, e.g., when the forks are resting on or in contact with the pallet. In some embodiments, this state can be achieved when the pallet contacts a lower surface of the forks-engaged sensor 210. The forks-engaged sensor 210 can detect a third state in which the pallet is not engaged or in contact with the forks. In various embodiments, this state can be achieved when the pallet does not contact the forks-engaged sensor 210 from the top or bottom.

In various embodiments, the forks-engaged sensor 210 is configured to provide feedback or a signal indicative of at least one state to forks monitoring system 220, which can in turn be in communication with payload engagement module 185 for forks manipulation. In various embodiments, forks-engaged sensor 210 can be configured to generate and send a signal for the first and second states indicating that the forks are either in contact with a top surface of the pallet or a bottom surface of the pallet. In either case, the vehicle will not retract the forks. Additionally, or alternatively forks detection sensor 210 can be configured to generate and send a signal indicating the third state, in which the forks can be retracted. Sending a signal indicative of the first state can cause the payload engagement module to lower the forks until the state is cleared. Sending a signal indicative of the second state can cause the payload engagement module to raise the forks until the state is cleared.

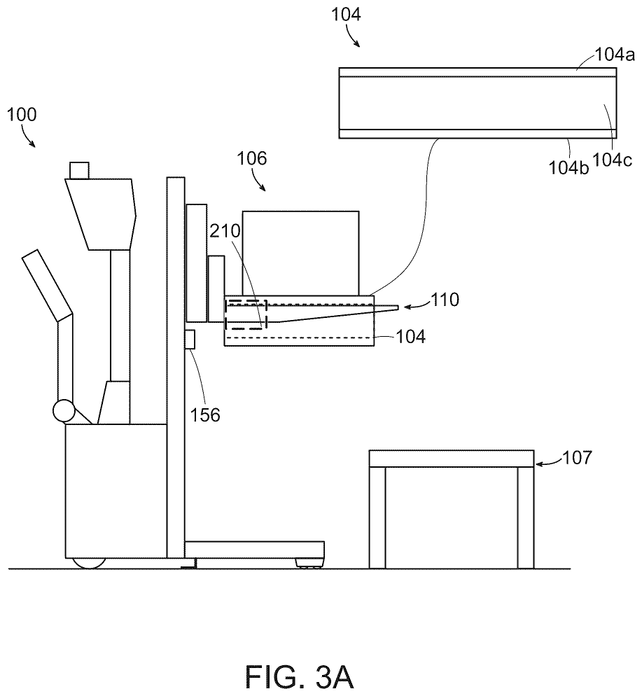

FIGS. 3A and 3B provide a side view of an AMR 100 lowering a pallet 104 carrying a payload 106 onto a drop surface, namely table 107, in accordance with aspects of the inventive concepts. Pallet 104, as a form of fork-engageable object, can comprise a top deck 104a, a bottom deck 104b, and a void 104c formed therebetween. In various embodiments, the top deck, bottom deck, and void can form or include fork pockets configured to receive the forks, i.e., fork time of a pair of forks.

In FIG. 3A, pallet 104 is being carried by the AMR. When AMR 100 carries pallet 104, forks 110 are engaged with top deck 104a of the pallet. When forks 110 lower the pallet onto the drop surface of table 107, forks 110 remain engaged with the top deck of the pallet. The AMR may then lower the forks slightly to begin disengaging from the pallet. While top deck 104a remains engaged with detection switch 210, a first state is detected indicating that forks 110 are engaged with/resting on top deck 104a of pallet 104. The AMR, or payload engagement module 185, will not extract (pull) the forks 110 in the first state.

If forks 110 are lowered such that the pallet contacts bottom deck 104c of the pallet, the forks will engage detection sensor 210. The AMR 100 will detect the second state and generate a signal indicating this condition. Forks 110 will not extract (pull) the forks 110 in the second state. Instead, the AMR will raise the forks until the condition ceases to be detected. The AMR, or payload engagement module 185, will not extract (pull) the forks 110 in the second state.

Once forks 110 no longer contact the top or bottom decks, the forks-engaged sensor 210 will detect the third state and retract the forks. In some embodiments, the absence of a signal indicating the first or second states can be interpreted by the forks monitoring systems as the third state. In other embodiments, a forks disengaged signal can be generated, by the forks-engaged sensor and/or the forks monitoring system when in the third state. In various embodiments, the forks monitoring system interprets signals and/or the absence of signals from the forks-engaged sensor to then signal the payload engagement module to retract the forks.

In FIG. 3B the AMR has lowered the palletized load onto a drop surface of table 107. Pallet 104 is resting on the drop surface of table 107, and top deck 104a of pallet 104 is not engaged with/resting on the forks 110. Forks 110 are also not engaged with/resting on the bottom deck 104c of pallet 104, so the forks 110 occupy a contact-free space within void 104c, between top deck 104a and bottom deck 104b. As such, forks-engaged sensor 210 is free from engagement or contact with the pallet 104. Thus, in some embodiments, forks-engaged sensor 210 provides feedback and/or a signal indicating that the forks 110 are in the third state and, in response, the AMR 100 may retract the forks 110 from the pallet 104—without dragging the pallet. Otherwise, in an absence of a signal from the forks-engaged sensor of a first or second state, the forks monitoring system determines the forks to be in the third state and signals the payload engagement module that the forks can be safely retracted.

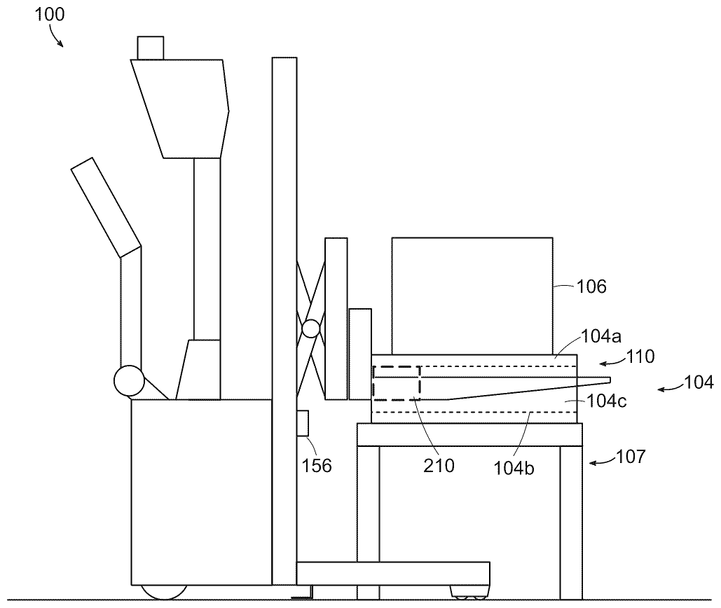

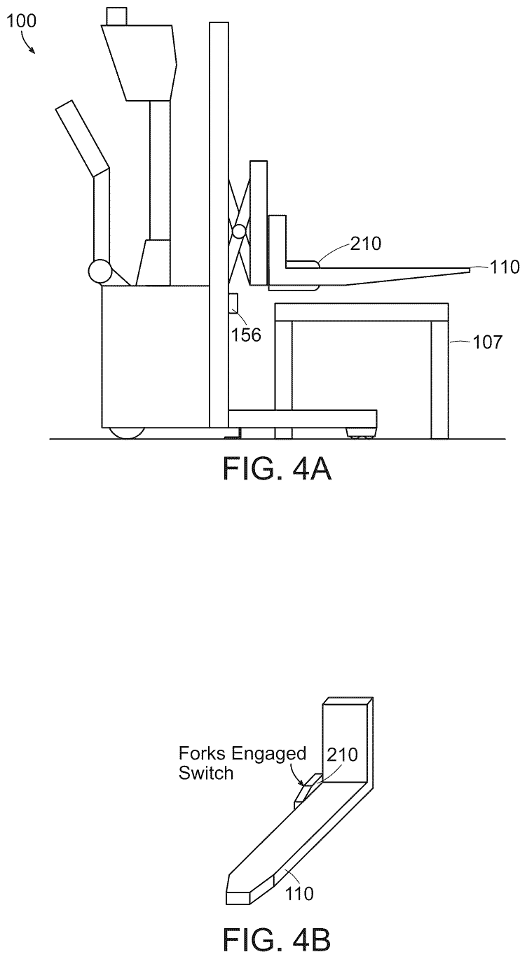

FIG. 4A provides a side view of an AMR 100 having embodiment of a forks-engaged sensor 210. FIG. 4B provides a perspective view of forks 110 of the AMR 100 of FIG. 4A with forks-engaged sensor 210. In FIGS. 4A and 4B, forks-engaged sensor 210 is shown as a retractable feeler; however, the present inventive concepts are not limited thereto. For example, in some embodiments, forks-engaged sensor 210 may be implemented using a contactless photoelectric sensor(s). In some embodiments, forks-engaged sensor 210 can be or include at least one switch. In such embodiments, the at least one switch can be or include at least one feeler switch. In such embodiments, the feeler switch can be or include at least one retractable feeler switch. In other embodiments, forks-engaged sensor 210 can be or include another type of mechanical or electromechanical sensor or switch, e.g., a weight transducer, or compression sensor.

In the embodiment in which the forks-engaged sensor 210 is a retractable feeler, the forks engagement detection sensor 210 is moved up or down when in contact with the pallet 104, and takes a neutral position when there is no contact from the top deck or bottom deck of the pallet.

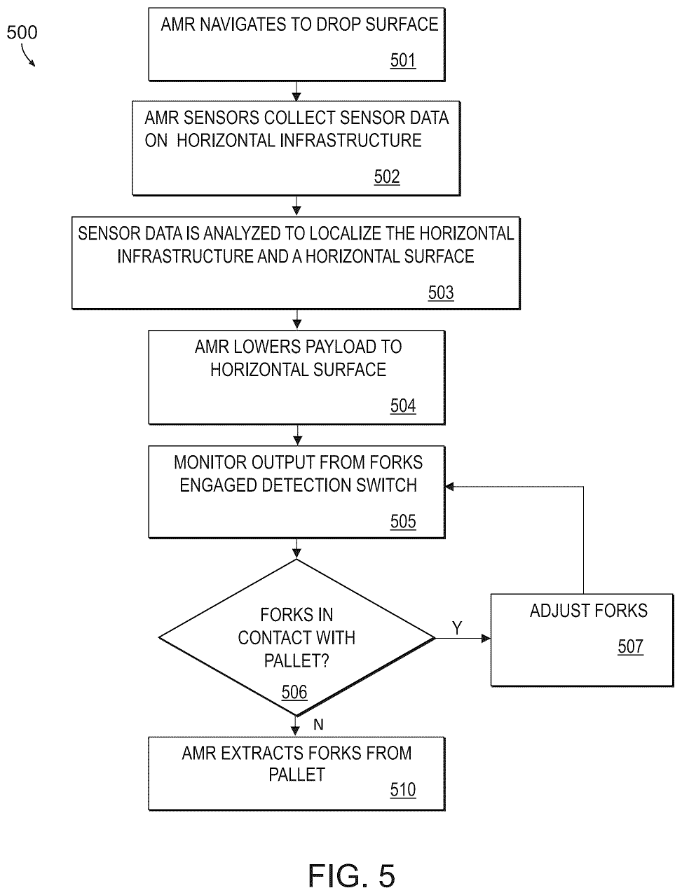

FIG. 5 is a flow diagram of an embodiment of a method 500 for vertically positioning forks of an AMR for retraction, in accordance with aspects of the inventive concepts.

In step 501, an AMR 100 navigates to a drop surface. In step 502, the AMR sensors collect sensor data on a horizontal infrastructure, namely, table 107. In step 503, the sensor data is analyzed to localize the horizontal infrastructure and a horizontal surface, as a drop surface in a delivery or drop operation. In step 504, the AMR lowers the payload to the horizontal surface. In step 505, forks monitoring system 220 of the AMR monitors an output from forks engaged detection switch 210. In step 506, forks monitoring system 220 determines whether the forks are engaged with the pallet, e.g., first or second state, based on the output from the forks-engaged sensor 210. If the forks are still in contact with the pallet, the method continues to step 507 where the payload engagement module adjusts the forks, e.g., iteratively up or down in response to a signal from the forks monitoring system indicating the forks are at least partially engaged with the pallet. In the first state, in response to the forks monitoring system outputting a signal indicating the forks are engaged with a top deck of the pallet, the payload engagement module vertically adjusts a position of the forks downward relative to the top deck of the pallet. In the second state, in response to the forks monitoring system outputting a signal indicating the forks are engaged with a bottom deck of the pallet, the payload engagement module vertically adjusts a position of the forks upward relative to the bottom deck of the pallet. The monitoring in step 505 is performed and the method returns to step 506. If, in step 506, it was determined that the forks were no longer in contact with the pallet, e.g. third state, the forks monitoring system 220 signals the payload engagement module that the forks can be retracted from the pallet, without dragging the pallet.

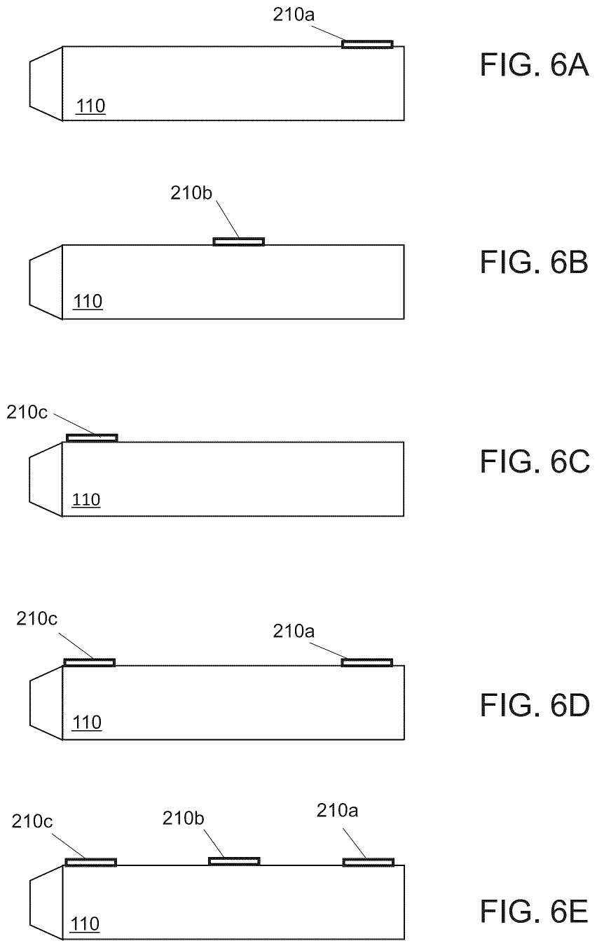

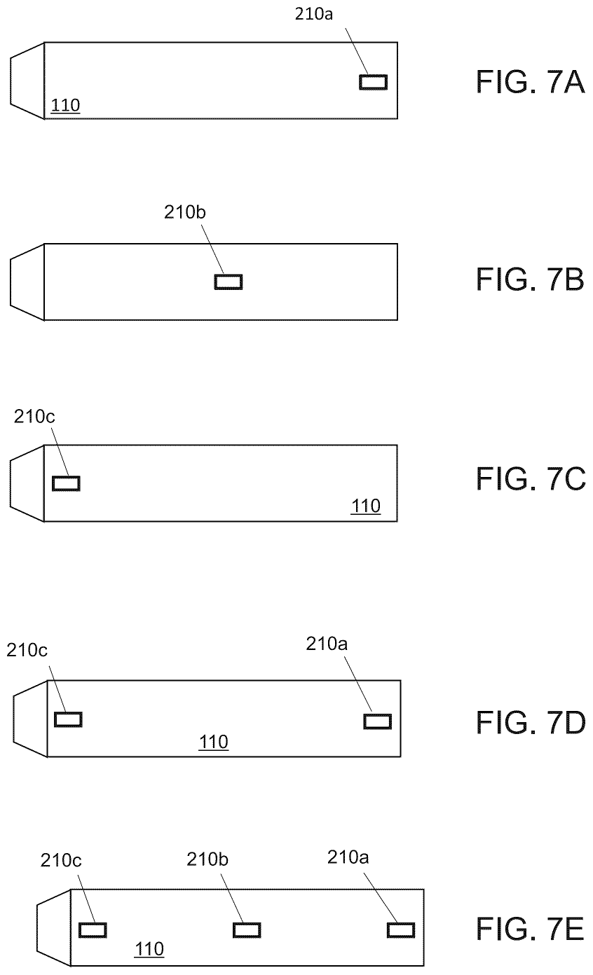

An AMR, or other mobile robot configured to carry a fork-engageable object or payload, may comprise a pair of forks having at least one fork tine (or fork) 110 comprising one or more fork detection sensors 210. FIGS. 6A through 6E show different embodiments of a fork tine having at least one fork detection sensor, in accordance with aspects of the inventive concepts. FIGS. 7A through 7E show other embodiments of a fork tine having at least one fork detection sensor, in accordance with aspects of the inventive concepts.

In FIGS. 6A through 6E, the sensors are located at or coupled to a lengthwise edge of the fork tine. FIG. 6A shows an embodiment where a proximal sensor 210a, located close to the AMR body, is coupled to or formed within the fork tine 110. FIG. 6B shows an embodiment where an intermediate sensor 210b, located between a proximal end and a distal end of the fork tine, is coupled to or formed within the fork tine 110. FIG. 6C shows an embodiment where a distal sensor 210c, located at a distal end of the fork tine, is coupled to or formed within the fork tine 110. FIG. 6D shows an embodiment where the fork tine includes a plurality of sensors, here the proximal sensor 210a and the distal sensor 210c, coupled to or formed within the fork tine 110. Other embodiments could include the intermediate sensor 210b and the proximal sensor 210a and/or the distal sensor 210c. FIG. 6E shows an embodiment where the fork tine includes a plurality of sensors, here the proximal sensor 210a, the intermediate sensor, and the distal sensor 210c, coupled to or formed within the fork tine 110.

In FIGS. 7A through 7E, the sensors are located between the lengthwise edges of the fork tine. FIG. 7A shows an embodiment where a proximal sensor 210a, located close to the AMR body, is coupled to or formed within the fork tine 110. FIG. 7B shows an embodiment where an intermediate sensor 210b, located between a proximal end and a distal end of the fork tine, is coupled to or formed within the fork tine 110. FIG. 7C shows an embodiment where a distal sensor 210c, located at a distal end of the fork tine, is coupled to or formed within the fork tine 110. FIG. 7D shows an embodiment where the fork tine includes a plurality of sensors, here the proximal sensor 210a and the distal sensor 210c, coupled to or formed within the fork tine 110. Other embodiments could include the intermediate sensor 210b and the proximal sensor 210a and/or the distal sensor 210c. FIG. 7E shows an embodiment where the fork tine includes a plurality of sensors, here the proximal sensor 210a, the intermediate sensor, and the distal sensor 210c, coupled to or formed within the fork tine 110.

In the embodiments of FIGS. 6A through 6E, the sensor or sensors are located at a lengthwise edge of the fork tine. In the embodiments of FIGS. 7A through 7E the sensor or sensors are located between the lengthwise edges of the fork tine. In other embodiment, the fork tine could include a plurality of sensors, including a combination of at least one edge sensor and at least one sensor between the edges of the fork tine.

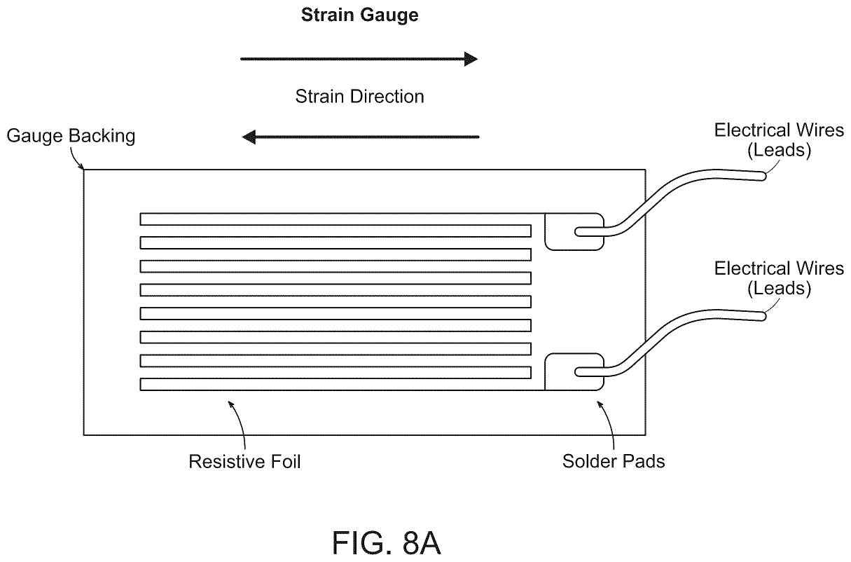

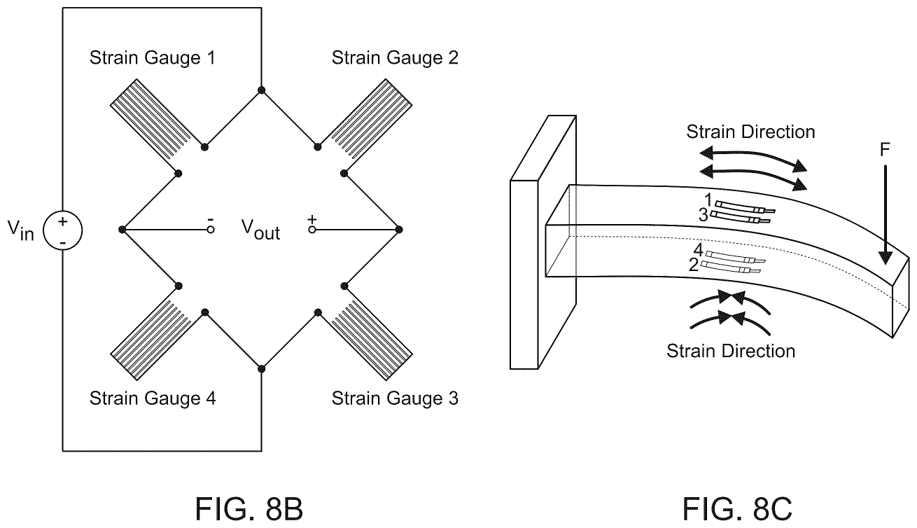

FIG. 8A shows a strain gauge sensor, in accordance with aspects of the inventive concepts. FIG. 8B shows a circuit diagram of strain gauge sensors embedded in a fork tine, in accordance with aspects of the inventive concepts. FIG. 8C shows strain gauge sensors embedded in a fork tine measuring a force applied to the fork tine.

In FIGS. 8A through 8C, at least one strain gauge sensor is embedded in at least one of the fork tines. In FIGS. 8B and 8C, first (1), second (2), third (3) and fourth (4) strain gauge sensors are embedded in a fork tine.

A strain gauge is a sensor whose measured electrical resistance varies with changes in strain. Strain is the deformation or displacement of material that results from an applied stress. Stress is the force applied to a material, divided by the material's cross-sectional area. Load cells are designed to focus stress through beam elements where strain gauges are located. Strain gauges convert the applied force F, pressure, torque, ect., into an electrical signal which can be measured. Force causes strain, which is then measured with the strain gauge by way of a change in electrical resistance. Then the voltage measurement is gathered using data acquisition.

The strain gauge includes a resistive foil on a gauge backing. The resistive foil is coupled to electrical wires (leads) via solder pads. The electric leads provide electrical signals to the forks engaged monitoring system 220.

Multiple strain gauges can be used in a divided bridge circuit to measure small changes in electrical resistance. This is called a Wheatstone bridge. In a Wheatstone bridge configuration, an excitation voltage is applied across the circuit, and the output voltage is measured across two points in the middle of the bridge. When there is no load acting on the load cell, the Wheatstone bridge is balanced and there is zero output voltage. Any small change in the material under the strain gauge results in a change in the resistance of the strain gauge as it deforms with the material. This causes the bridge to be thrown out of balance, resulting in a change in the output voltage. The resistance change is minute, which means that signal amplification is often needed to properly determine changes. The amplification process strengthens the strain signal changes; however, it also leads to more unwanted noise also being detected in the signal. Signal conditioning filters out the excess noise, ensuring accurate and understandable data.

When the strain gauge sensors embedded in the fork tines measure a change in resistance, the forks monitoring system 220 of the AMR determines that the forks are engaged with the pallet, e.g., first or second state, based on the output from the strain gauge sensors. If the forks are still in contact with the pallet, the payload engagement module adjusts the forks, e.g., iteratively up or down. If the strain gauge sensors do not measure a change in resistance, the forks monitoring system 220 signals the payload engagement module that the forks can be retracted from the pallet, without dragging the pallet.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. An autonomous mobile robot, comprising:
at least one processor in communication with at least one computer memory device;
fork tines configured to engage a forks-engageable payload; and
a forks monitoring system comprising at least one forks-engaged sensor configured to acquire data indicating at least partial engagement of the fork tines with the forks-engageable payload, and
configured to determine if the fork tines are at least partially engaged with the forks-engageable payload based on outputs from the at least one forks-engaged sensor.

2. The mobile robot of claim 1, wherein the at least one forks-engaged sensor comprises at least one sensor coupled to or within one or more of the fork tines.

3. The mobile robot of claim 2, wherein the at least one forks-engaged sensor comprises at least one sensor coupled to or within each fork tine.

4. The mobile robot of claim 2, wherein the at least one forks-engaged sensor comprises at least one sensor coupled to or within only one of the fork tines.

5. The mobile robot of claim 2, wherein the at least one forks engaged-sensor comprises a plurality of sensors coupled to or within at least one fork tine.

6. The mobile robot of claim 1, wherein the at least one forks engaged-sensor comprises at least one fork tine having a plurality of sensors.

7. The mobile robot of claim 6, wherein the at least one fork tine having a plurality of sensors includes a fork tine having a plurality of sensors located at different locations along a length of the fork tine.

8. The mobile robot of claim 1, wherein the at least one forks-engaged sensor comprises a sensor at a proximal end of a fork tine.

9. The mobile robot of claim 1, wherein the at least one forks-engaged sensor comprises a sensor at an intermediate location of a fork tine.

10. The mobile robot of claim 1, wherein the at least one forks-engaged sensor comprises a sensor at a distal end of a fork tine.

11. The mobile robot of claim 1, or any preceding claim, wherein the at least one forks-engaged sensor comprises at least one retractable feeler switch.

12. The mobile robot of claim 1, or any preceding claim, wherein the at least one forks-engaged sensor comprises at least one strain gauge sensor.

13. The mobile robot of claim 1, further comprising:
a payload engagement module configured to adjust a position of the fork tines in response to a signal from the forks monitoring system indicating the fork tines are at least partially engaged with the forks-engageable payload.

14. The mobile robot of claim 13, wherein the payload engagement module is configured to vertically adjust a height of the fork tines.

15. The mobile robot of claim 14, wherein the payload engagement module is configured to raise the fork tines in response to the forks monitoring system outputting a signal indicating the fork tines are engaged with a bottom deck of the forks-engageable payload.

16. The mobile robot of claim 14, wherein the payload engagement module is configured to lower the fork tines in response to the forks monitoring system outputting a signal indicating the fork tines are engaged with a top deck of the forks-engageable payload.

17. The mobile robot of claim 13, wherein the payload engagement module is further configured to retract the fork tines in response to the forks monitoring system outputting a signal indicating the fork tines are disengaged from the forks-engageable payload.

18. The mobile robot of claim 13, wherein the forks monitoring system is configured to:
indicate a first state when the at least one forks-engaged sensor determines that the fork tines are engaged with a top deck of the forks-engageable payload;
indicate a second state when the at least one forks-engaged sensor determines that the fork tines are engaged with a bottom deck of the forks-engageable payload; and/or
indicate a third state when the at least one forks-engaged sensor determines that the forks are positioned in a void between the top deck and the bottom deck of the forks-engageable payload.

19. The mobile robot of claim 18, wherein in the first state the payload engagement module is configured to vertically adjust a position of the fork tines downward relative to the top deck.

20. The mobile robot of claim 18, wherein in the second state the payload engagement module is configured to vertically adjust a position of the fork tines upward relative to the bottom deck.

21. The mobile robot of claim 18, wherein in the third state the payload engagement module is configured to retract the fork tines from the forks-engageable payload.

22. The mobile robot of claim 1, further comprising at least one sensor configured to collect sensor data of a horizontal infrastructure indicating a pose of a horizontal drop surface.

23. The mobile robot of claim 22, wherein the payload engagement module is further configured to use the sensor data to position the forks-engageable payload on the horizontal surface.

24.-74. (canceled)
